(19) United States
(12) Patent Application Publication
(10) Pub. No.: US 2026/0052121 A1
(43) Pub. Date: Feb. 19, 2026

(54) METHOD AND DEVICE FOR INTERFACING A MOBILE NETWORK TO A REMOTE NETWORK THROUGH AN ACCESS NETWORK

(71) Applicant: FREE MOBILE, Paris (FR)

(72) Inventors: Alexandre Cassen, Paris (FR); Sylvain Cadilhac, Draveil (FR)

(21) Appl. No.: 19/232,742

(22) Filed: Jun. 9, 2025

(30) Foreign Application Priority Data
Jul. 3, 2024 (EP) 24315319.4

(51) Int. Cl. H04L 61/2503; H04W 8/26

(52) U.S. Cl. CPC H04L 61/2503; H04W 8/26

(57) ABSTRACT

An interface couples a mobile network of a mobile phone network operator to a fixed access network of a fixed network operator, to allow a user equipment connected to the mobile network to access a private or public target network via the access network. The interface comprises, on the mobile network side, a stack of protocols including: i) an Ethernet link layer, and ii) a mobile network protocol layer incorporating UE's identification data provided by the mobile network. The interface comprises, on the network side, a stack of protocols including an Ethernet link layer with a virtual MAC address. The interface is adapted to generate the virtual MAC address by incorporating a UE-specific unique identifier, derived from the International Mobile Subscriber Identity, IMSI, identifying the UE's user, included in the UE's identification data provided by the mobile network and incorporated in the mobile network protocol layer of the mobile network-side protocol stack, to translate the mobile network protocol into an Ethernet protocol directly usable by the target network after having been analyzed and interpreted by the fixed access network of the fixed network operator.

The invention relates to interfacing between mobile networks and fixed networks. The matter is to allow a user equipment (hereinafter “UE”) connected to a mobile phone network (3G/4G/5G/ . . . ) (hereinafter “mobile network”) to access to remote fixed networks (hereafter “target networks”), in particular private networks such as corporate extranets, but also possibly public networks such as Internet.

### STATE OF THE ART

Taking an LTE-type mobile network as an example, its base architecture includes a plurality of base stations (eNBs), attached to a network core or EPC (Evolved Packet Core) interconnecting the different users to each other and to remote networks and services (Internet, dematerialised databases, etc.).

However, reference to an LTE (4G) network technology, with in particular its own terminology such as “EPC”, is made only by way of non-limiting example insofar as, as will be understood, the method of the invention can be implemented independently of the mobile network technology used (the network core being thus called “5GC” (5G Core) in 5G technology, etc.).

The EPC of an LTE operator is interfaced with the eNBs via a RAN (Radio Access Network). EPCs mainly comprise SGWs (Serving Gateways) that convey data traffic (in the user plane) and concentrate the traffic of several eNBs, and MMEs (Mobility Management Entities) that manage (in the control plane) the mobility signalling and give access to the HSS/HLR (Home Subscriber Server/Home Location Register) databases containing the subscribers' identifiers and rights. Moreover, one or more PGWs (Packet GateWays) ensure the exchanges towards the Internet and assign IP addresses to UE terminals. The PGWs receive data collected by the SGW from the UEs, and act as gateways between the IP network of the mobile network operator and the Internet, by routing data from the UE to Internet and vice versa. More precisely, each time a user of the mobile network wants to connect to the Internet or to a VPN (Virtual Private Network), its UE uses an APN (Access Point Name) to select a PGW to route the UE's traffic. The subscriber is identified on the PGW by its IMSI (International Mobile Subscriber Identity), and the UE is identified on the PGW by its IMEISV (International Mobile Station Equipment Identity Software Version). The PGW contains the access conditions and the routing to provide the service to the subscriber. These technologies and protocols are specific and complex, and hence require expensive, specialized network equipment, and expert personnel capable of designing and operating them.

Actually, the increase in the number of potential users-up to several hundred thousands-means that more equipment is needed, in particular at the PGW level in order to have sufficient access capacity for establishing all the communications and conveying and routing data traffic from and to the users' UEs.

### SUMMARY OF THE INVENTION

The object of the invention is to simplify this conventional architecture.

In particular, as will be seen, the invention makes it possible to do without the conventional mobile network PGWs, by replacing these latter at the interfacing between the mobile network and the fixed network by a “software brick” implemented at the protocol stacks.

Essentially, this interface according to the invention translates the mobile network protocol (generally a GTP, GPRS Tunneling Protocol) into an Ethernet protocol directly usable by the target network after having been analyzed and interpreted by the network of the fixed network operator (broadband network hereinafter called “access network”) that couples the mobile network to the private target networks (directly, without passing by the Internet) or public target networks (in particular, Internet).

However, it will be noted that, if the invention makes it possible, as will be seen, to replace one or more PGWs by a simple software brick ensuring the PGW function, this substitution is however not necessary insofar as, in a specific use, the invention can also be implemented, for example, in the context of a proxy providing intermediation between an SGW and a PGW in a pre-existing network architecture. To achieve the above-mentioned aims, the invention proposes a method for establishing a connection to a public target network by a mobile user equipment, UE, connected to a mobile phone network of a mobile phone network operator, the link to the target network being operated through a fixed access network of a fixed network operator.

According to the invention: the method implements, between the mobile network and the access network, an interface coupled to the mobile network via a mobile network protocol and coupled to the access network via an access network protocol, the interface comprising respective protocol stacks on a mobile network side and on an access network side; the interface comprises, on the mobile network side, a stack of protocols including: i) an Ethernet link layer, and ii) a mobile network protocol layer incorporating UE's identification data provided by the mobile network; the interface comprises, on the access network side, a stack of protocols including an Ethernet link layer with a virtual MAC address; and the method comprises a step of creating the virtual MAC address by incorporating an UE-specific unique identifier, derived from an International Mobile Subscriber Identity, IMSI, identifying the UE's user, included in said UE's identification data provided by the mobile network and incorporated in the mobile network protocol layer of the mobile network-side protocol stack, to translate the mobile network protocol into an Ethernet protocol directly usable by the target network after having been analyzed and interpreted by the access network of the fixed network operator.

The invention also encompasses as such the connection interface implemented by this method, said interface comprising: on a mobile network side, a stack of protocols including: i) an Ethernet link layer, and ii) a mobile network protocol layer incorporating UE's identification data provided by the mobile network; and on an access network side, a stack of protocols including an Ethernet link layer with a virtual MAC address. The interface is adapted to generate the virtual MAC address by incorporating an UE-specific unique identifier, derived from an International Mobile Subscriber Identity, IMSI, identifying the UE's user, included in said UE's identification data provided by the mobile network and incorporated in the mobile network protocol layer of the mobile network-side protocol stack, to translate the mobile network protocol into an Ethernet protocol directly usable by the target network after having been analyzed and interpreted by the access network of the fixed network operator.

According to various subsidiary advantageous features:
the method further comprises, by an equipment device of the access network: receiving a transmission from the mobile network via the interface; analyzing said UE's identification data provided by the mobile network and incorporated in the mobile network protocol layer of the mobile network-side protocol stack; and routing the transmission towards the target network;
the equipment device is then advantageously an input/output gateway of the access network of a Border Network Gateway, BNG, type;
the UE designating the target network by an Internet domain name, the method further comprises: obtaining an IP address by a Domain Name System, DNS, service; and routing of the transmission towards the target network is operated as a function of the DNS-resolved IP address or a previously DNS-resolved Internet domain name;
the interface implements within the mobile network a gateway function of a Packet Data Network Gateway, P-GW, type;
the method operates a plurality of simultaneous connections of UE to the access network with, for each connection, a specific Access Point Name, APN, and an distinct associated virtual MAC address;
the mobile network protocol is a GPRS Tunneling Protocol, GTP;
the access network protocol is an Ethernet protocol, or is a PPP over Ethernet protocol, PPPOE, encapsulating a Point-to-Point Protocol, PPP, into an Ethernet protocol, and the link layer of the access network-side protocol stack comprises a PPP header in addition to the virtual MAC address.

### BRIEF DESCRIPTION OF THE DRAWINGS

FIG. 1 shows a schematic overview of the environment of the various networks likely to be interconnected by implementation of the teachings of the invention.

FIG. 2 illustrates the protocol stacks of the interface according to the invention, on the mobile network side and on the access network side, in a first embodiment of the invention.

FIG. 3 is homologous to FIG. 2, in a second embodiment of the invention.

FIG. 4 explains, with a particular example, the way to generate a virtual MAC address according to the teachings of the invention.

### DESCRIPTION OF THE EMBODIMENTS

An example of implementation of the invention will now be described, with reference to the attached drawings in which the same references designate identical or functionally similar elements throughout the figures.

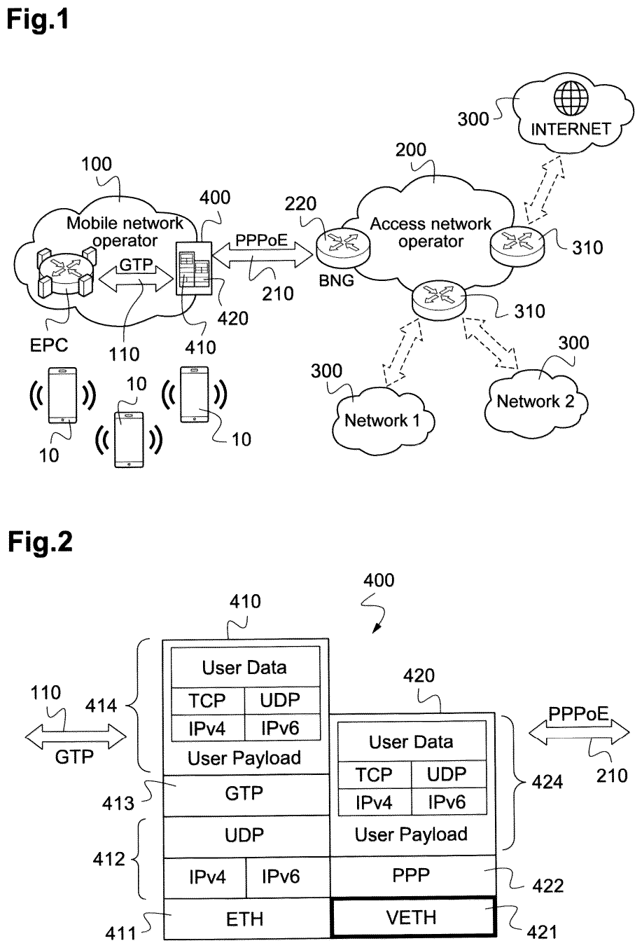

In FIG. 1, reference 100 designates a cellular mobile telephone network, managed by a mobile network operator in accordance with the conventional GSM, UMTS, LTE, LTE-A, NR, etc. (3G, 4G, 5G, . . . ) specifications, that are not modified by the implementation of the invention in the mobile network 100.

The users of this mobile network, each with their own user equipment, UE, connect by radio to base stations or eNBs linked to an EPC network core interconnecting the different UEs to each other and to remote networks or services out of the mobile network 100.

The invention is precisely in the latter case, where a user of a UE 10 wants to access a remote network 300, in particular a private network such as a corporate extranet (“Network 1”, “Network 2” in FIG. 1), but also possibly to a public network such as Internet.

Access to these remote networks, hereinafter called “target networks”, is operated by an intermediate broadband network or “access network” 200, managed by a fixed network operator that may be the same as, or different from, the mobile network operator 100.

The most commonly used protocols for this purpose are i) within the mobile network 100, GTP (GPRS Tunneling Protocol), which is an IP-based protocol used for packet transfer in mobile networks and ii) between the mobile network and the access network, an Ethernet protocol or, most often, PPPOE (PPP over Ethernet), which is an encapsulation of a PPP (Point-to-Point Protocol) over Ethernet, by adding a specific PPP header to the Ethernet link layer.

GTP is used on the link 110 between the EPC network core and a mobile network router, which is a PGW in a conventional configuration.

PPPOE (or PPP) establishes a tunnel between a router of the mobile network (the PGW in a conventional configuration) and a router 220 of the access network, typically an access equipment of the BNG (Border Network Gateway) input/output gateway type, that aggregates the traffic from the different UEs connected to the mobile network and routes this traffic towards the next node of the access network. Other BNGs, referenced 210, provide interconnection of the access network 200 with the remote, private or public, target networks 300.

The method of the invention is implemented by an interface referenced 400 in FIG. 1, with a mobile network-side protocol stack 410 and an access network-side protocol stack 420.

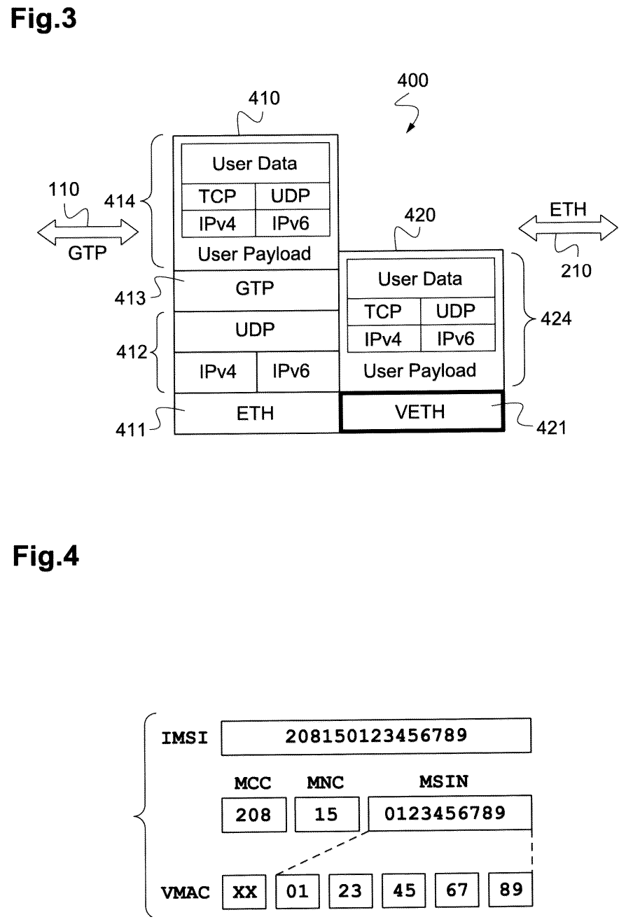

These protocol stacks 410 and 420 are shown in detail in FIGS. 2 and 3, respectively, in the case of GTP/PPPOE and GTP/Ethernet interfacing.

FIG. 2 illustrates in details the stack of protocols according to the invention in the embodiment in which the interfacing is operated between, on the mobile network side, a GTP-protocol flow and, on the access network side, a PPPoE-protocol flow. The mobile network-side protocol stack 410 comprises, in succession, from the highest to the lowest layers:
in 414, the user data passing through the mobile network from or to the UE, which are not modified by the interfacing operation;
in 413, a GTP layer corresponding to the data session by UE as the latter has been identified by the mobile network, this layer thus containing the UE's identifiers within the mobile network, in a header of the GTP layer;
in 412, an UDP (User Datagram Protocol)/IPv4 (Internet Protocol version 4) or IPv6 (Internet Protocol version 6) layer, for conveying GTP information of layer 413; and
in 411, an Ethernet link layer, corresponding to local data (having no relation with the UE nor with the target network) relating to the mobile network equipment (router, PGW, . . . ) of the current session with the UE.

The access network-side protocol stack 420 comprises, in succession, from the highest to the lowest layers:
in 424, the user data, the content of this layer 424 being identical to that of the access network-side layer 414;
in 422, a PPP (Point-to-Point Protocol) layer, and
in 421, a virtual Ethernet layer VETH, formed in a manner that will be described hereinafter with reference to FIG. 4.

The virtual Ethernet addresses of layer 421 are unique virtual MAC addresses identifying the UEs on the access network. It will be noted that a same UE can initiate and use several simultaneous connections to the access network, for example a connection for data exchange, a connection for voice on IP (VOLTE, Voice over LTE), one for SMS or MMS exchange, etc., with, for each connection, a specific APN and a distinct associated virtual MAC address.

The analysis of the VETH layer 421 by the access network, combined with the analysis of the PPP layer 422, to determine the way to transmit the frame, allows the access network to provide interconnection between, on the one hand, the UE in the mobile network, and on the other hand, the target network with which the UE wants to exchange user data contained in the bloc 410/420 of the interface 400. In the variant of FIG. 3, the mobile network is directly interfaced with the access network by an Ethernet protocol, the encapsulation PPP layer 422 is thus no longer necessary.

All the other protocol stack layers of the interface, both on the mobile network side and on the access network side, are functionally identical to those of FIG. 3, and will therefore not be described again.

In either case (PPPOE interfacing or Ethernet interfacing on the access network side), the virtual Ethernet address incorporates, as indicated hereinabove, a unique UE-specific identifier, which is derived from the UE's identification data provided by the mobile network and incorporated in the GTP layer 413 of the mobile network-side protocol stack; and that for each connection of each UE in the case of several simultaneous connections.

In a particularly advantageously embodiment, the virtual MAC address is formed from the IMSI (International Mobile Subscriber Identity) of the UE's terminal user, according to the allocation diagram shown in FIG. 4.

An IMSI consists in a MMC (Mobile Country Code), a MNC (Mobile Network Code) and a MSIN (Mobile Subscriber Identification Number) allocated by the operator within its network.

Only the MSIN of the IMSI is taken into account to construct the virtual MAC address. The MSIN is preferably used with the digits in BCD (Binary Coded Decimal) format to allocate the MAC address digits.

In EUI-48 format, a MAC address comprises 48 bits (6 bytes). The MSIN digits form the 5 least significant bytes of the VMAC address, the leading byte being reserved. It is therefore possible to define 64 VMAC addresses for each IMSI 64 (the first byte being reserved for the two U/L and I/G bits).

The way the interface according to the invention operates will now be described, with a virtual MAC address formed that way.

In the case of a GTP/PPPOE interfacing (case of FIG. 2), when the UE initiates a connection, the BNG access equipment 220 of the access network receives a PPPOE connection request containing UE-specific information, such as the session IMSI, IMEI, etc. If necessary, the BNG 220 may be used as a LAC (L2TP Access Concentrator) and send back the traffic in L2TP (Layer 2 Tunneling Protocol) to an LNS (L2TP Network Server) on another network. Otherwise, it may process directly the PPPOE flow, send back to the mobile parameters such as an IP address and/or a DNS (Domain Name System) service address, and place the PPP session in the required target network. Afterwards, the BNG 220 will only have to route the IP traffic on PPPOE between the mobile network and the target network.

In the case of a GTP/Ethernet interfacing (case of FIG. 3), when the terminal initiates a connection, the interface 400 translates it into a DHCP (Dynamic Host Configuration Protocol) request. The BNG 220 then receives this request, whose source is the virtual MAC address allocated by the interface 400 and containing, in accordance with the DHCP, information such as the IMSI, the IMEI, an APN to which the UE wants to access, etc. The BNG 220 can then place the session in the required target network, apply thereto routing and Quality of service, QoS, profiles, and communicate in response elements such as the IP address to be used, the DNS servers, etc. The interface 400 translates this response to the network core of the mobile network, and will then only have to route the IPoE (Internet Protocol over Ethernet) traffic.

1. A method for establishing a connection to a private target network or to a public target network by a mobile user equipment, UE, connected to a mobile phone network of a mobile phone network operator, the link to the target network being operated through a fixed access network of a fixed network operator,
wherein the method implements, between the mobile network and the access network, an interface coupled to the mobile network via a mobile network protocol and coupled to the access network via an access network protocol, the interface comprising respective protocol stacks on a mobile network side and on an access network side,
wherein the interface comprises, on the mobile network side, a stack of protocols including: i) an Ethernet link layer, and ii) a mobile network protocol layer incorporating UE's identification data provided by the mobile network, wherein the interface comprises, on the access network side, a stack of protocols including an Ethernet link layer with a virtual MAC address,
and wherein the method comprises a step of creating the virtual MAC address by incorporating a unique UE-specific identifier, derived from an International Mobile Subscriber Identity, IMSI, identifying the UE's user, included in said UE's identification data provided by the mobile network and incorporated in the mobile network protocol layer of the mobile network-side protocol stack, to translate the mobile network protocol into an Ethernet protocol directly usable by the target network after having been analyzed and interpreted by the access network of the fixed network operator.

2. The method of claim 1, further comprising,
by an equipment device of the access network:
receiving a transmission from the mobile network via the interface;
analyzing said UE's identification data provided by the mobile network and incorporated in the mobile network protocol layer of the mobile network-side protocol stack; and
routing the transmission towards the target network.

3. The method of claim 2, wherein:
the UE designates the target network by an Internet domain name;
the method further comprises: obtaining an IP address by a Domain Name System, DNS, service; and
routing of the transmission towards the target network is operated as a function of the DNS-resolved IP address or a previously DNS-resolved Internet domain name.

4. The method of claim 2, wherein the equipment device is an input/output gateway of the access network of a Border Network Gateway, BNG, type.

5. The method of claim 1, wherein the interface implements within the mobile network a gateway function of a Packet Data Network Gateway, P-GW, type.

6. The method of claim 1, comprising a plurality of simultaneous connections of the UE to the access network with, for each connection, a specific Access Point Name, APN, and an distinct associated virtual MAC address.

7. The method of claim 1, wherein the mobile network protocol is a GPRS Tunneling Protocol, GTP.

8. The method of claim 1, wherein the access network protocol is an Ethernet protocol.

9. The method of claim 1, wherein the access network protocol is a PPP over Ethernet protocol, PPPOE, encapsulating a Point-to-Point Protocol, PPP, into an Ethernet protocol, and wherein the link layer of the access network-side protocol stack comprises a PPP header in addition to the virtual MAC address.

10. An interface for connecting a mobile phone network of a mobile phone network operator to a fixed access network of a fixed network operator, to allow a mobile user equipment, EU, connected to the mobile network to access a private target network or a public target network via the access network,
wherein the interface comprises, on a mobile network side, a stack of protocols including: i) an Ethernet link layer, and ii) a mobile network protocol layer incorporating UE's identification data provided by the mobile network, wherein the interface comprises, on an access network side, a stack of protocols including an Ethernet link layer with a virtual MAC address,
and wherein the interface is adapted to generate the virtual MAC address by incorporating an UE-specific unique identifier, derived from an International Mobile Subscriber Identity, IMSI, identifying the UE's user, included in said UE's identification data provided by the mobile network and incorporated in the mobile network protocol layer of the mobile network-side protocol stack, to translate the mobile network protocol into an Ethernet protocol directly usable by the target network after having been analyzed and interpreted by the access network of the fixed network operator.

11. The interface of claim 10, wherein the mobile network protocol is a GPRS Tunneling Protocol, GTP.

12. The interface of claim 10, wherein the access network protocol is an Ethernet protocol.

13. The interface of claim 10, wherein the access network protocol is a PPP over Ethernet protocol, PPPOE, encapsulating a Point-to-Point Protocol, PPP, into an Ethernet protocol, and wherein the link layer of the access network-side protocol stack comprises a PPP header in addition to the virtual MAC address.
